(19) United States
(12) Patent Application Publication
(10) Pub. No.: US 2025/0077627 A1
(43) Pub. Date: Mar. 6, 2025

(54) Systems and Methods for Scalable Management and Distribution of Digital Assets

(71) Applicant: Intertrust Technologies Corporation, Berkeley, CA (US)

(72) Inventors: Vishisht Tiwari, Sunnyvale, CA (US); Yutaka NAGAO, Minami-Alps (JP); Jayant Kannadkar, Sunnyvale, CA (US); Guido Cugi, Sunnyvale, CA (US)

(73) Assignee: Intertrust Technologies Corporation, Berkeley, CA (US)

(21) Appl. No.: 18/821,822

(22) Filed: Aug. 30, 2024

Related U.S. Application Data
(60) Provisional application No. 63/535,846, filed on Aug. 31, 2023.

(51) Int. Cl. G06F 21/10; G06F 21/60

(52) U.S. Cl. CPC G06F 21/1014; G06F 21/602

(57) ABSTRACT

Embodiments of the disclosed systems and methods provide for the scalable management of digital assets. Assets may be associated with digital tokens which may be used in connection with various disclosed management paradigms. Certain disclosed embodiments may use master and copy tokens associated with an asset, with asset metadata being associated with master tokens and copy tokens including a reference to corresponding master tokens. In this matter, an update in metadata for an asset may involve updating the master token metadata, with the updates being inherited by associated copy tokens referencing the mater token. In addition, segment-based content encryption techniques are presented for generate unique copies of an asset at scale.

### CROSS-REFERENCE TO RELATED APPLICATIONS

This application claims the benefit of priority under 35 U.S.C. § 119 (e) to U.S. Provisional Application No. 63/535,846, filed Aug. 31, 2023, and entitled “Token Generation and Management Systems and Methods,” which is hereby incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY OF THE INVENTION

The present disclosure relates generally to systems and methods for managing digital assets. More specifically, but not exclusively, the present disclosure relates to systems and methods for managing digital assets and their associated distribution at scale using non-fungible tokens (“NFTs”) and/or asset encryption techniques.

The distribution of digital content and associated assets in a secure and managed manner presents many challenges, particularly in terms of scalability. One common approach involves representing digital assets as non-fungible tokens (“NFTs”), with ownership and rights managed via blockchain technology. An NFT is a type of cryptographic token on a trusted distributed ledger (e.g., a blockchain ledger) that may represent an asset, which may be a digital and/or a physical asset. In some embodiments, an NFT may be associated with a digital asset and/or rights associated with a digital asset (e.g., a digital content asset). In further embodiments, an NFT may be associated with a physical asset and/or a product, operating like a unique serial number associated with a product.

When multiple copies of an NFT linked to a specific asset are created, ensuring that any updates (such as changes to associated metadata) are accurately and efficiently reflected across all copies becomes increasingly difficult. This creates challenges in managing and updating NFTs at scale.

Additionally, in the context of collectible items, especially media assets like video and audio files, creating and storing unique copies and/or instances of the digital assets can be resource intensive. For instance, a 2-hour movie in 4K resolution, encoded at a bitrate of 30 Mbps, may in some circumstances result in a file size of approximately 25 GB. The encoding and packaging process for such a file could take around 2 hours and produce various renditions (e.g., SD, HD, Full HD, UHD), which may involve around 40 GB of storage space in total. If separate storage is needed for different streaming protocols (e.g., Dynamic Adaptive Streaming of HTTP (“DASH” and HTTP Live Streaming (“HLS”)), this storage requirement could potentially double to 80 GB. When multiple copies of such an asset are needed, the resource demands scale accordingly. For example, in some circumstances, generating 100 individual copies may involve 4 TB of storage and roughly 200 hours for packaging and encoding.

Embodiments of the systems and methods described herein may use marketplace services for managing assets and/or associated NFTs. Metadata associated with assets may be stored in a server database, and the correlation of assets and associated metadata may be securely stored in a trusted ledger, such as a blockchain ledger. Embodiments of the disclosed systems and methods may use digital rights management (“DRM”) technology in connection with NFT management paradigms.

In various disclosed embodiments, trusted ledgers and/or the like, may be used to record and/or otherwise manage various assertions associated with assets and/or NFTs. In some embodiments, such ledgers may be distributed, and may be referred to herein as trusted immutable distributed assertion ledgers (“TIDALs”) and/or variations of the same. In some embodiments, trusted ledgers may comprise blockchain ledgers.

Ledgers may, in various embodiments, be public, private, and/or a combination thereof. In certain embodiments, a TIDAL may comprise a public indelible distributed database (“PIDD”). TIDALs consistent with various aspects of the disclosed embodiments may be associated with a variety of properties including, for example, ledger processes that may be resistant to byzantine failures, entries that may be immutable and/or relatively immutable, entries that may be time-synced (at least in part), entries that may be scalable, and/or entries that may be available for relatively fast lookup.

Embodiments of the disclosed systems and methods may facilitate various rights management and/or asset management operations in connection with a variety of NFT transactions. These may include, for example and without limitation, creation of NFTs associated with assets and/or copies and/or instances of assets (e.g., minting of NFTs), secure association of creator, author, and/or other rightsholder information with assets, creation and/or management of certain business conditions, parameters, contracts, and/or agreements associated with assets, listing of assets in connection with a marketplace, and/or the like. In some implementations, these operations and/or aspects thereof may facilitate compensation of rights holder(s) associated with assets. In certain embodiments, one or more commercial blockchain ledgers may be employed such as, for example, the FLOW blockchain, and blockchain connector and/or integration services may provide mechanisms to readily implement aspects of the disclosed systems and methods with such established blockchain architectures.

In certain embodiments, marketplace services are described that facilitate, among other things, payment from consumers and/or other parties to artists, creators, and/or rightsholders, interactions with media services including content distribution network(s) and/or packaging services, management of rights to digital assets using key management and/or DRM services and/or blockchain services, which may associate assets (e.g., digital assets and/or physical assets that may be represented digitally) with tokens (e.g., NFTs) that may be managed using trusted ledgers and/or blockchains. In addition, fractional ownership rights may be associated and managed in connection with digital assets in connection with embodiments of the disclosed marketplace services. Fractional ownership models may, among other things, enable multiple parties to acquire shares in content and allowing them to earn revenue based on the financial performance of the content.

Certain embodiments may provide for scalable solutions for minting and/or otherwise creating tokens and/or NFT at scale, which may be applicable in circumstances where a larger number of copies of a digital asset are available within a marketplace service. Consistent with embodiments disclosed herein, paradigms that use master tokens and copy tokens may be used which allow for minting, creation, and/or other token management operations at scale. For example, in some embodiments, in various embodiments, an asset may be associated with multiple minted tokens. An initial token associated with the first asset copy may be associated with a master token, with further copies of the asset being associated with copy tokens. Metadata associated with the asset may be stored in the master token, with copy tokens referencing the master token. In this manner, an update in metadata for all copies of an asset may involve updating the master token without needing to individually update each and every associated copy token, mitigating challenges posed by certain computational limitations of blockchain services.

In additional embodiments, segment-based content encryption techniques may be used to efficiently generate distinct instances and/or copies of a digital asset in a relatively scalable manner. In some embodiments, a digital asset may be divided into a plurality of segments. For example a media content file may be divided into a plurality of media segments. Segments may be encrypted using a set of encryption keys, with each unique instance of the asset being associated with a distinct combination of the encryption keys. This process may ensure the uniqueness of each instance, while reducing computational overhead and/or storage requirements.

### BRIEF DESCRIPTION OF DRAWINGS

The inventive body of work will be readily understood by referring to the following detailed description in conjunction with the accompanying drawings, in which:

FIG. 1 illustrates a non-limiting example of a digital asset management ecosystem consistent with certain embodiment disclosed herein.

FIG. 2 illustrates a non-limiting example of a token minting process consistent with certain embodiment disclosed herein.

FIG. 3 illustrates a flow chart of a non-limiting example of a method for minting asset tokens associated with a plurality of asset copies consistent with certain embodiments of the present disclosure.

FIG. 4 illustrates a non-limiting example of a segment-based content encryption process to generate unique instances of an asset consistent with certain embodiments disclosed herein.

FIG. 5 illustrates a flow chart of a non-limiting example of a method of generating asset copies consistent with certain embodiments of the present disclosure.

FIG. 6 illustrates a non-limiting sequence diagram of a method for packaging and encrypting a digital content asset consistent with certain embodiments disclosed herein.

FIG. 7 illustrates a non-limiting example of various components of a packaging service for packaging and encrypting a digital content asset consistent with certain embodiments disclosed herein.

FIG. 8 illustrates a non-limiting example of the generation of encrypted copies of a digital asset consistent with certain embodiments disclosed herein.

FIG. 9 illustrates an example of a system that may be used to implement certain embodiments of the systems and methods of the present disclosure.

### DETAILED DESCRIPTION OF THE INVENTION

A description of systems and methods consistent with embodiments of the present disclosure is provided herein. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to certain drawings. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure, but is merely representative of possible embodiments of the disclosure. In addition, the steps of any method disclosed herein do not necessarily need to be executed in any specific order, or even sequentially, nor need the steps be executed only once, unless otherwise specified. Moreover, it will be understood that, as used herein, a process and/or method step that is described as being “based on” some information is not necessarily exclusively based on that information, but indeed may be based at least in part on the information and/or a portion thereof and/or other information, even if not explicitly indicated as so. Moreover, it will be appreciated that all examples described herein are intended to be illustrative of applications of various embodiments of the disclosed systems and methods to facilitate an understanding of the embodiments, and are not intended to be limiting examples, even if not specifically identified as such.

Embodiments of the disclosed systems and methods may provide for dynamic management of content, products, and/or other assets and/or associated NFTs in a secure way, where the rights of rights holders in such assets, products, and/or NFTs are definable in a manner such that they can be respected and/or otherwise enforced. It will be appreciated that the disclosed systems and methods and aspects thereof may be employed in connection with a variety of types of assets, content, and/or data including, for example and without limitation, physical assets and/or products, audio content, video content, multimedia content, software, data (which may comprise proprietary data and/or databases), and/or the like. In this manner, the terms “content” and/or derivatives as used herein thereof should be considered to encompass a relatively broad variety of possible types of content and/or data. Moreover, it will be appreciated that the term “asset” may comprise both physical and digital assets and/or products.

Various embodiments disclosed herein may use trusted ledgers to securely record certain assertions relating to the digital content, products, rightsholders, and/or various ecosystem participants. Such assertions may be used in connection with rights binding, content packaging, management, and/or protection operations in connection with a variety of transactions associated with assets, products, and/or associated NFTs.

In some embodiments, a ledger may comprise a blockchain. For example and without limitation, in some embodiments, a blockchain may comprise a TIDAL and/or another suitable trusted ledger service that may be provided by a trusted data management platform (“TIP”) service and/or another service or entity. Although various examples described herein may use a TIDAL, it will be appreciated that various embodiments and aspects of the disclosed systems and methods may be implemented using a variety of other trusted ledgers and/or blockchains that may, or may not, have certain attributes associated with a TIDAL. As used herein, a TIDAL may generally describe an assertion ledger having certain properties of a TIDAL as detailed herein (and/or a subset thereof), and in some instances may describe a TIDAL with entries derived and/or otherwise generated based on entries in one or more other ledgers and/or TIDALs, which in some instances may be referred to alternatively and/or additionally as a derivative TIDAL. A blockchain function service may further offer a blockchain wallet service function, although it will be appreciated that in some embodiments, the wallet service may be implemented by a separate and/or otherwise different service and/or system.

In various embodiments, and as discussed in more detail below, a blockchain service may employ a scalable tokenization paradigm when multiple tokens representing multiple logical copies of an asset are minted. For example, consistent with embodiments disclosed herein, an initial (which may be referred to as an original) logical instance and/or copy of an asset may be associated with a minted master token. The master token may comprise and/or otherwise with associated with metadata associated with the asset. Further logical instances and/or copies of the asset may be associated with minted copy tokens, which in some embodiments may be serialized. The copy tokens may reference the master token in a manner such that metadata associated with the master token is inherited by the copy tokens. In this manner, updates made to the master token metadata may be inherited by all copy tokens referencing the master token, thereby streamlining metadata updates associated with asset copies.

In some implementations, an asset management ecosystem may employ a media service providing asset file storage and/or package services. A media service may further be used in connection with asset and/or content distribution (which may comprise streaming) operations and/or interact with another distribution service implementing such functionalities. In certain embodiments, segment-based encryption content techniques may be used by a media service and/or an associated packaging service to efficiently generate distinct instances and/or copies of a digital asset in a relatively scalable manner. For example, a digital asset may be divided into a plurality of segments. Segments may be encrypted using a set of encryption keys, with each unique instance of the asset being associated with a distinct combinations of the encryption keys used to encrypt constituent segments.

### Marketplace Services and Asset Management

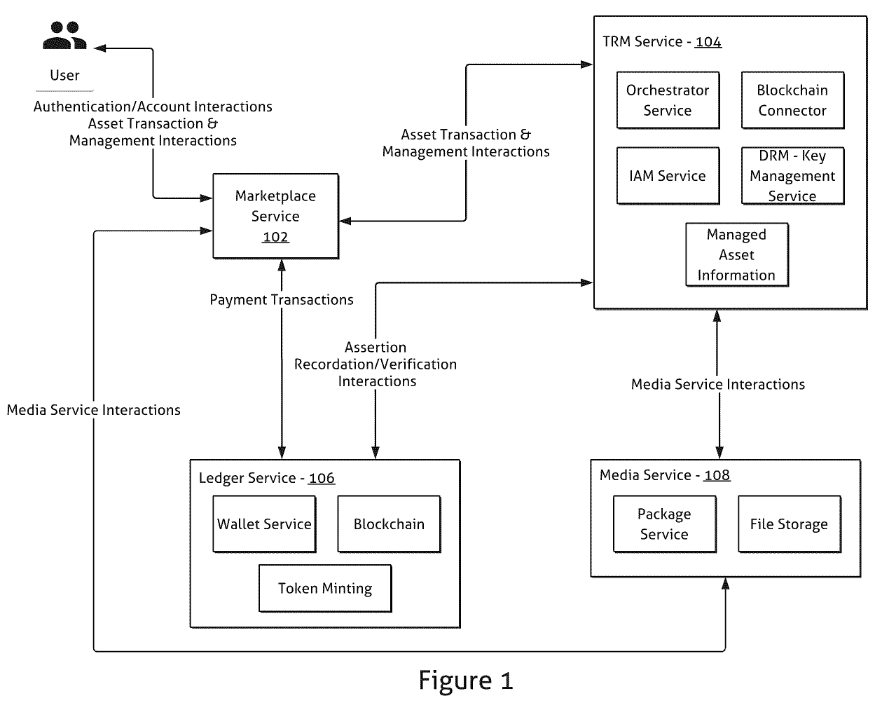

FIG. 1 illustrates a non-limiting example of an asset management ecosystem consistent with certain embodiment disclosed herein. As shown, a user may interact with a marketplace service 102 in connection with various asset management interactions and/or interactions. In some embodiments, the user may be an original rights holder, an owner (e.g., an owner in entirety and/or a fractional owner), a rights holder, a buyer, a renter, and/or a consumer of an asset, and/or any other entity interacting with the marketplace service 102. In further embodiments, as discussed in more detail below, other services may interact with the marketplace service 102 including, for example and without limitation, media and/or content distribution services.

Users and/or services may among other things, manage their accounts with the marketplace service 102, login and/or authenticate access with the marketplace service 102, and/or engage in a variety of asset and/or content transactions with the marketplace service 102. The marketplace service 102 may interact with a TRM system 104 in connection with a variety of asset and/or NFT management processes consistent with various disclosed embodiments.

The TRM system 104 may include, for example and without limitation, an orchestrator service, an identity and access management (“IAM”) service, a DRM service and/or key management service (“KMS”) (which indeed may be the same service), a blockchain connector service facilitating interactions with a trusted ledger and/or ledger service 106, managed asset information, which may comprise a variety of metadata and/or information relating to managed assets, potentially including managed asset files themselves. In connection with various transactions and/or interactions relating to managed assets, the TRM system 104 may interact with a media service 108 and/or a trusted ledger service 106.

The media service 108 may offer certain asset file storage services and/or package services, which may be leveraged by the TRM service 104 (and/or by the marketplace service 102 via the TRM service 104 or directly). For example, in some embodiments, the package service may encrypt asset files and save encrypted asset files on a file store. The package service may further generate asset and/or transaction IDs associated with a managed asset and provide links (e.g., URLs) to allow access to managed assets to permitted parties. Media services 108 and/or associated package services may further allow for digital assets to be packaged into products, serialized, and/or managed in accordance with one or more enforced business conditions.

Business conditions may include permitted actions that may be performed in connection with an asset and/or an associated product and may be set by entities that hold certain rights to the digital asset and/or associated product. For example and without limitation, business conditions may be used to manage digital assets and/or associated NFTs based on sell models, rental models, subscription models, rent-ownership models, and/or the like, which may be managed by the marketplace service 102 and/or the TRM service 104.

The trusted ledger service 106 may provide various trusted ledger and/or blockchain and/or cryptographic wallet services which may be leveraged by the marketplace service 102 and/or the TRM service 104 in connection with the disclosed embodiments. For example, a blockchain ledger managed by the ledger service 106 may be used to securely record certain assertions relating to assets, products, rightsholders, and/or various ecosystem participants. Such assertions may be used in connection with rights binding, content packaging, management, and/or protection operations in connection with a variety of transactions associated with digital assets, products, and/or associated NFTs.

Interactions between the marketplace service 102, the TRM service 104, the media service 106, and the ledger service 108 may facilitate a number of asset management interactions and/or transactions including, for example and without limitation, registering and/or uploading of assets and/or NFTs, creation of managed products associated with assets, purchasing and/or accessing assets (e.g., download, playback, etc.) via a variety of access paradigms (e.g., rental, sale, etc.), updating assets and/or products, deleting managed assets and/or products, bundling and/or unbundling assets and/or products, inviting and/or disinviting collaborators to interact with managed assets and/or products, transferring ownership rights of assets, products, and/or associated tokens, including fractional ownership rights and/or other rights (e.g., revenue rights), asset transaction history management, and/or the like.

As noted above, the ledger service 108 may be used to generate tokens (which may be referred to in certain instances herein as “minting” a token) that represent an asset and may be used in connection with managing the asset and/or associated copies in embodiments of disclosed asset management ecosystem. For example, as described in more detail below, the ledger service 108, potentially in conjunction with other services, may be used to mint a master token associated with an initial copy of an asset that includes asset metadata. Further copies may be associated with minted copy tokens that reference the master token.

In further embodiments, the media service 106 and/or an associated packaging service may be used to package and/or otherwise encrypt content based on segment-based encryption content techniques consistent with the disclosed systems and methods. For example, the packaging service may divide a media asset into a plurality of asset segments, with segments being encrypted with a set of encryption keys in a manner such that each asset copy uses a distinct combination of the encryption keys to encrypt its constituent segments.

### Asset Management Using Tokens

Consistent with various disclosed embodiments, the disclosed systems and methods may provide mechanisms for the creation of content within a creator platform where unique asset items may be associated with NFTs and/or other managed unique identifiers. In certain embodiments, a number of copies of an asset may be associated with a number of minted and/or otherwise generated tokens. As noted above, in certain applications, however, it may become more difficult to batch update metadata associated with multiple copies of an asset token at scale. With each copy, a part of the associated metadata may be saved on corresponding token information including, for example and without limitation, the title, the URL and/or other location of the encrypted media asset, and any other metadata requested by the marketplace operator, asset providers, creators, and/or the like. In some implementations, an update in this metadata may involve a signed transaction that updates metadata in each copy of an NFT. If the number of copies increase, however, transaction computational limits enforced by blockchain services (e.g., the FLOW blockchain) may be reached.

In certain implementations, this scalability problem may be ameliorated by dividing a number of copy tokens being updated into multiple transactions. For example and without limitation, 1,000 tokens may be updated where the batch update is divided into multiple transactions (e.g. if 1000 tokens are to be updated, the updated may be divided into constituent transactions of 300 tokens+300 tokens+300 tokens+100 tokens). In some implementations, when a single account requests simultaneous updates for multiple copies of a token, a blockchain service may require a different private key to be used to sign the transactions. This may by extension require an account to have multiple keys to make parallel signed transactions with the service, causing potential key management issues at scale.

### Updating of Tokens

Consistent with embodiments disclosed herein, batch updating of tokens may be achieved while supporting various blockchain and token management operations including, for example and without limitation, one or more of minting of tokens in implementations where the number of copies of an asset is not particularly large, improved minting of tokens in implementations where the number of copies of an asset is large, fractional ownership support, updating of metadata for all copies associated with an asset, updating and/or retrieving ownership, renter, and/or invitee (e.g., collaborator or associate of an rightsholder that may have viewing rights) information and/or status for tokens, and/or retrieving metadata information for tokens.

Various embodiments disclosed herein may employ paradigms that use master tokens and copy tokens which allow for minting, creation, and/or other token management operations at scale. Consistent with embodiments disclosed herein, tokens associated with each asset may be divided into one master token and multiple copy tokens. Minted assets may have one master token associated with an initial serial number (e.g., serial number 0). Thereafter, any further copies minted for the above asset—that is, assets associated with a copy token—may include a reference to the master token and may be associated with sequential serial numbers (e.g., 1, 2, 3, etc.).

In some embodiments, the structure of the master and copy tokens may be similar, with metadata being stored in the master token and inherited by copy tokens that reference the master token. In certain embodiments, a database service of a marketplace service may store an asset token ID of the master token for every asset. With this architecture, an update in metadata may involve updating the master token, with associated copy tokens inheriting this update by their referencing of the master token. Among other things, this may help ameliorate token update challenges under certain computational limitation mandates from blockchain services. In some embodiments, the similar structure between master and copy tokens may also allow the use of a smaller number of token types (e.g., one token type and smart contract) to be used for the architecture.

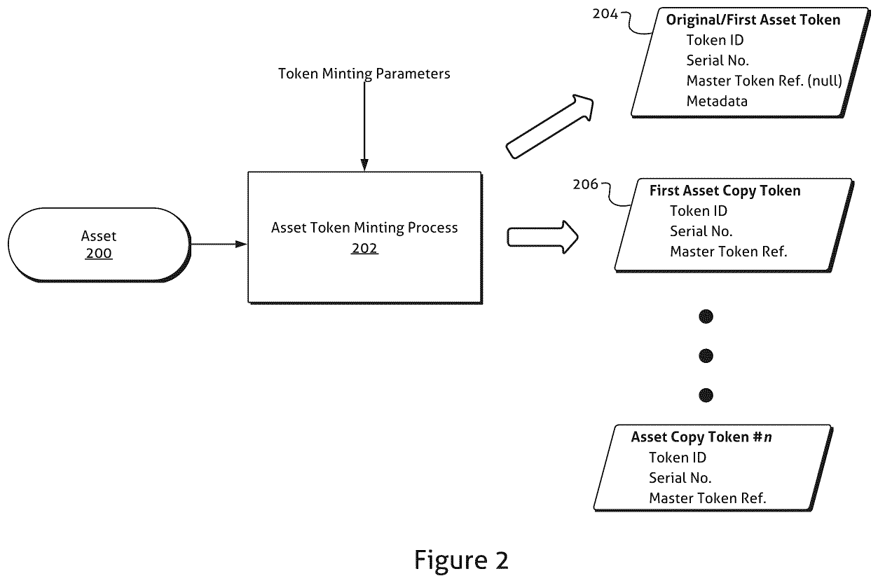

FIG. 2 illustrates a non-limiting example of a token minting process consistent with certain embodiments disclosed herein. An asset 200, which may comprise a digital asset, such as an electronic content asset, and/or a physical asset, may be represented and managed in an asset management ecosystem consistent with disclosed embodiments using one or more tokens (e.g., an NFT). As noted above, the process of generating one or more tokens associated with an asset may, in certain instances, be referred to herein as “minting” a token.

In certain embodiments, an asset may be associated with a single token, as may be the case when a creator, owner, and/or rightsholder of an asset may wish for there to be only one managed copy of the asset. In further embodiments, however, an asset may be associated with multiple logical copies managed in connection with a plurality of associated tokens. For example, a content creator, owner, and/or rightsholder may wish for a limited release of token managed copies of an asset. Accordingly, a plurality of tokens, subject to the conditions of the limited release, may be minted associated with the asset.

An asset token minting process 202, which may be implemented by a ledger service and/or another service included in and/or otherwise associated with an asset management ecosystem, may be used to generate one or more tokens 204, 206 associated with the asset 200. In various embodiments, the tokens 204, 206 may be generated based, at least in part, on token minting information which may comprise one or more token minting parameters provided to the asset token minting process 202.

A variety of parameters and/or information may be included in the token minting information. For example and without limitation, the token minting information may specify to the asset token minting process a number of tokens that should be minted for the asset. For example and without limitation, if a digital asset is to be associated with a limited release of 1,000 associated tokens, the token minting information may specify that only 1,000 tokens should be minted for the asset by the asset token minting process 202. This information may be received and enforced by the asset token minting process 202 (and/or an associated service and/or system) in connection with token minting operations for the asset.

Token minting information provided to the asset token minting process 202 may further comprise, for example and without limitation, one or more of metadata associated with the asset, ownership and/or rightsholder information associated with the asset, and indication of certain available rights associated with the asset (e.g., rental rights, invitee rights, etc.), and indication of whether the asset and/or associated minted tokens are to be public and/or private tokens, and/or the like.

Metadata associated with the asset may comprise a variety of information including, for example and without limitation, a title of an asset, a description of the asset and/or additional content associated with the asset, original creator, author, owner, and/or other bibliographic information associated with the asset, a URL and/or other link associated with the asset (e.g., a location of the asset), and/or the like. It will be appreciated that a wide variety of metadata may be associated with an asset and/or associated tokens, and that the specific examples of metadata used herein are not to be considered limiting. While certain non-limiting examples presented herein include certain information in metadata and other information as being separate from metadata, metadata as used herein may or may not include this specific information. Moreover, certain information described herein as being separate from metadata may indeed be included in metadata in other implementations.

It will be appreciated that information included in master and/or copy tokens may be structured in a variety of suitable ways. Non-limiting examples of the structure of master and copy tokens are detailed below.

### Example—Master Token

ID-532
serialNumber—0
masterTokenld—None/−1
title—“Asset Title 1”
url—“https://www.encryptedfileurl.com”
metadata—{description: “Asset Description 1”, poster: “Asset Poster 1”}
ownership—{owner1: 500, owner2: 500}
totalTokens—1000
renters—[“renter1”, “renter2”]
invitees—[“invitee1”, “invitee2”]
type-public/private

### Example—Copy Token

ID—533
serialNumber—1
masterTokenld—532
title—″″
url—″∝
metadata—{description: ″″, poster: ″″}
ownership—{owner1: 500, owner3: 500}
totalTokens—1000
renters—[“renter1”, “renter3”]
invitees—[“invitee1”, “invitee3”]
type—public/private

### Token Minting Operations

Master and/or copy tokens consistent with embodiments disclosed herein may be used to manage assets under a variety of tokenization and/or asset copy paradigms including, for example and without limitation, minting of a single token for an asset, minting of multiple token associated with managed copies an asset, and/or the like. Non-limiting examples of various token minting operations are detailed below.

### Example Token Minting Operations—Minting One Copy Per Asset

In connection with the architecture described above, minting one copy—that is, one token for an asset—may involve minting a master token for the asset with associated metadata. In some embodiments, the master token may comprise serial number information indicating the token is an initial serialized token. In some embodiments, a field in the token used to indicate and/or otherwise reference another token may be left blank and/or otherwise have a null value as the original token is considered a master token and therefore does not reference another token (and/or its associated metadata). In further embodiments, rather than a reference token field indicating a blank or null value, this field may simply not be included in a master token.

Example Token Minting Operations—Minting Assets Where Copies/Assets are Relatively Low (e.g., <1000 copies)

Consistent with embodiments disclosed herein, an initial token associated with a first asset copy may be associated with a master token, with further copies of the asset being associated with copy tokens. Metadata associated with the asset may be stored in the master token, with copy tokens referencing the master token. For example, a master token may be initially minted. Once the master token is minted, additional copy tokens may be minted in accordance with token minting information and/or associated parameters, which may include an indication of a total number of copies to be minted, an initial and/or starting serial number of the copies (and/or the master token), and a reference and/or other indication of a master token associated with the asset. For example, in some embodiments, minted copy tokens may include an indication of a master token ID in a field of the token used to indicate and/or otherwise reference another token.

In some embodiments, copy token minting can be repeated multiple times, with increasing serial numbers associated with the resulting copy tokens, provided that the total copies remain below or equal to set value and/or a value indicated in associated minting information (e.g., 1000). Depending on the number of copies, this operation might be divided into multiple transactions by the backend APIs on an associated service.

To ensure that copies of other copy tokens are not created, in some embodiments, a smart contract may check that the serial number of the master token ID provided is 0 before minting any associated copy tokens. An additional option that can be implemented in various disclosed embodiments may be referred to in certain instances herein as lazy minting. Lazy minting may comprise an operation of minting the token only during the first transfer of an asset and not during and/or immediately following the asset creation process. In some embodiments, if minting tokens during asset creation is not desired, a lazy minting option can be provided.

Example Token Minting Operations—Minting Assets where Copies/Assets are Relatively High (e.g., >1000 Copies)

In certain embodiments, lazy minting operations may be used when the number of copies and/or assets is relatively high. As noted above, lazy minting may refer to the operation of minting the token only during the first transfer of an asset and not during the asset creation process. A master token may be minted initially, but additional copy tokens may be minted later by the token management service when purchasing and/or other transaction operations occur that are associated with authorized copies of the asset associated with the master token.

### Updating Metadata

As detailed above, in various disclosed embodiments, metadata may be included in and/or otherwise associated with a master token. Updating metadata associated with an asset may therefore involve updating the metadata of the master token, with the updates being inherited by associated copy tokens that refer to the master token. For example, following an update to master token metadata, if a party wishes to view metadata associated with a copy token, they will identify the reference in the copy token to the master token (e.g., a master token ID), and use this information to access the metadata associated with the master token.

In some embodiments, the master token ID for every asset may be fetched from a database service during an update operation. It may also be enforced in the smart contract that metadata update is only supported for master tokens. This operation may be agonistic of how many copies/asset are supported. A more customized feature can also be provided where a user can update metadata in a single token.

In some embodiments, metadata fields may be included in copy tokens, but may be left blank and/or have null values, indicating that metadata should be inherited from a referenced master token. In further embodiments, metadata fields may not be included in copy tokens. In yet further embodiments, initial metadata associated with copies of an asset may be included in the copy tokens in addition to the master tokens. This initial metadata may be used in the event that the reference master token cannot be checked to determine the most current and/or updated metadata for the asset, with the recognition by the checking system and/or an associated user that the initial metadata may be out of date.

### Updating Ownership, Renters, Invitees, and Status

In various embodiments, updating ownership, renters, invitees, and/or status information associated with a master token may further be inherited by copy tokens in a similar manner. Ownership, renters, invitees, and status information fetching operations may involve querying the blockchain with the corresponding asset token ID and retrieving the associated information.

### Fetching Metadata

In certain embodiments, metadata fetching operations may depend on if the metadata is being fetched for a master token or a copy token. In some embodiments, the smart contract may check if the serial number of the asset token ID being fetched is 0 or not, indicating whether the token associated with the asset token ID is an original and/or master token. If it is, then metadata may be returned from the token as the queried token is the master token. However, if the serial number is not 0, then the token would be identified as a copy token and no metadata would be directly available in this token. Consistent with embodiments disclosed herein, the ledger and/or blockchain service may then check the reference to the master token ID and will return the metadata from the referenced corresponding master token.

In some embodiments, customized update of metadata in a copy token may be provided. Under such an operation, a smart contract may first check if the metadata in question exists in the copy token or not. If it does not exist, then metadata may be fetched from the corresponding master token.

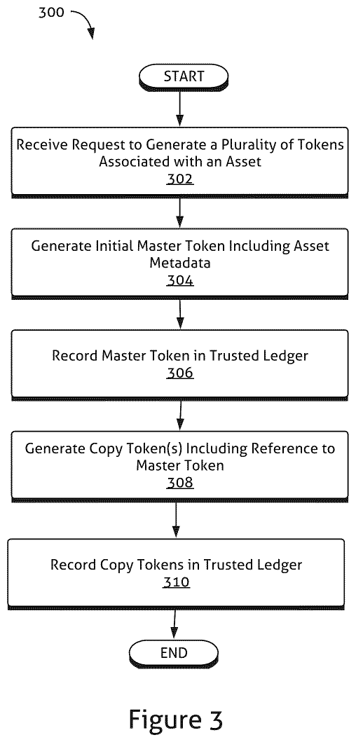

FIG. 3 illustrates a flow chart of a non-limiting example of a method for minting asset tokens associated with a plurality of asset copies consistent with certain embodiments of the present disclosure. The illustrated method 300 may be implemented in a variety of ways, including using software, firmware, hardware, and/or any combination thereof. In certain embodiments, various aspects of the method 300 and/or its constituent steps may be performed by a service, system, and/or device configured to implement embodiments of ledger and/or TRM service and/or any other suitable application, device, system and/or service or combination of applications, devices, systems, and/or services.

At 302, a ledger and/or TRM service (which indeed may be implemented by the same service) may receive a request to generate a plurality of NFTs associated with an asset. The asset may comprise a digital asset such as a digital content asset, which may comprise one or more of text content, audio content, and/or any other type of content. The request may comprise token minting information and/or token minting parameters. For example, the request may comprise an indication that N NFTs should be minted for the asset in response to the request. In various embodiments, the request may be received from a TRM service and/or an associated blockchain connector service by a ledger service.

A master token may be generated at 304 based on the request. The master token may comprise a token ID associated with the master token and metadata associated with the asset. The metadata may comprise a variety of information. For example and without limitation, the metadata may comprise one or more of title information associated with the asset, description information associated with the asset, ownership information associated with the asset, an indication of a location of the asset (e.g., a URL), and/or the like. The master token may further comprise a token serial number corresponding to an initial token serial number for the asset. At 306, the master token may be recorded in a trusted ledger such as a blockchain and/or TIDAL.

At 308, a set of N−1 copy tokens may be generated based on the request. Each copy token of the set of N−1 copy tokens may comprise a copy token identifier associated the respective copy token and a reference to the master token. In certain embodiments, the reference to the master token may comprise a token identifier associated with the master token. In further embodiments, each copy token of the set of N−1 copy tokens may comprise a token serial number for the respective copy token. The set of copy tokens may be recorded in the trusted ledger at 310.

In certain embodiments, the asset may comprise a content asset that includes a plurality of associated content segments. In some embodiments, the content segments may be encrypted. As discussed in detail below, for each unique copy of the content, a first subset of the content segments may be encrypted with one or more common encryption keys and a second subset of the content segments may be encrypted with one or more copy-specific encryption keys.

### Segment-Based Content Encryption

Consistent with embodiments disclosed herein, the scalability of the generation and/or distribution of assets, which may comprise digital content assets, may be improved using segment-based content encryption techniques consistent with various aspects of the disclosed systems and methods. Segment-based content encryption techniques may be used to efficiently generate distinct instances and/or copies of a digital asset by dividing a digital asset into a plurality of segments and encrypting the segments using a combination of encryption keys unique to the instance of the asset. This process may ensure the uniqueness of each instance, while reducing computational overhead and/or storage requirements.

In at least one non-limiting illustrative example, a copy of a video asset may be associated with 10 segments, with each segment being 10 seconds long (which in some implementations may be a typical segment length for DASH content). Segment files sizes at different rendering resolutions may be as follows:
UHD (2160p): Approximately 35.8 MB per 10-second segment.
Full HD (1080p): Approximately 9.54 MB per 10-second segment.
HD (720p): Approximately 5.96 MB per 10-second segment.
SD (480p): Approximately 2.98 MB per 10-second segment.

Hence, storing 10 segments from each rendition in the above example may require a total storage of approximately 500 MB. For 100 copies of the asset, this would therefore be approximately 50 GB of extra storage, which may in some implementations be approximately two orders of magnitude smaller than storage requirements involved if individual copies of the same asset were created.

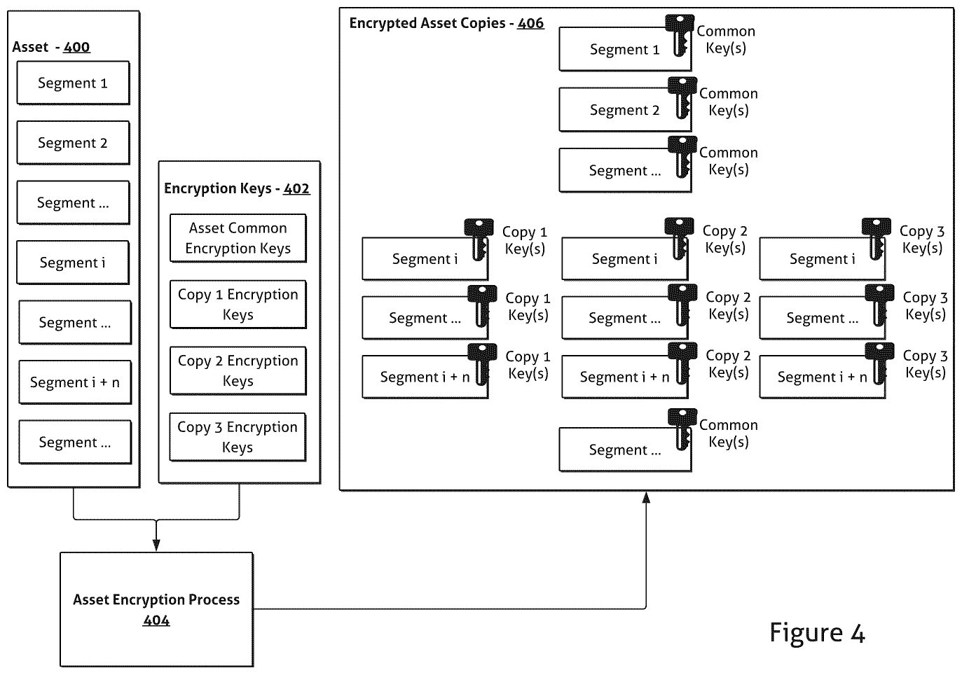

FIG. 4 illustrates a non-limiting example of a segment-based content encryption process to generate unique instances of an asset consistent with certain embodiments disclosed herein. As illustrated, in various embodiments, an asset 400, which in certain embodiments may comprise a digital content asset, may be divided into a plurality of constituent segments. A set of encryption keys 402 may be established that may be used to generate encrypted asset copies. The set of encryption keys may comprise one or more common encryption keys and one more copy encryption key(s) (e.g., sets of copy encryption keys).

The asset 400 and/or its constituent segments and/or the encryption keys 402 may be provided to an asset encryption process 404, which in certain embodiments may be implemented by a media service and/or an associated packaging service. Consistent with embodiments disclosed herein, segments of the asset 400 may be encrypted using the encryption keys, which each unique instance and/or copy of the encrypted asset being associated with a distinct combination of the encryption keys.

For example, as illustrated in FIG. 4, certain segments of the asset 400 may be encrypted using a common encryption key for the asset included in the set of encryption keys 402 across all instances and/or copies of the encrypted asset. Certain other segments of the asset 400, however, may be encrypted by a different encryption key and/or set of encryption keys in a manner such that a particular key and/or set of keys used to encrypt a particular segment and/or set of segment is unique for a particular asset instance and/or copy.

For example, as shown, a certain subset of the segments of asset 400 may be encrypted using the common encryption, while the other segments are encrypted with different copy encryption keys—that is Copy 1 Key(s), Copy 2 Key(s), and Copy 3 Key—to generate three unique encrypted copies of the asset. Although three copies of the asset are illustrated in the figure for purposes of simplicity and explanation, it will be appreciated that the methods disclosed herein may be extensible to create any suitable number of instances and/or copies of an asset using suitable sets of common and/or copy encryption keys.

In some embodiments, all segments of an asset may first be encrypted with the common encryption key, with a subset of the resulting encrypted segments being encrypted again encrypted using a copy encryption key and/or set of copy encryption keys. Although a single copy key for each asset copy and/or instance is shown in the figure for purposes of simplicity and explanation, it will be appreciated that in other embodiments, a plurality of copy keys may be used to encrypt copy-specific segment subsets, with the copy keys (and/or combinations of copy keys used) unique to a particular copy and/or instance of the asset.

Segments of an asset 400 that are encrypted using copy keys consistent with various aspects of the disclosed embodiments may be identified and/or otherwise selected in a variety of ways. For example, in some embodiments, the encrypted copy specific segments may be identified based on a random selection of constituent segments of an asset. In further embodiments, some defined segment encryption schema and/or structure may be used, where certain locations and/or subsets thereof for encryption using copy specific keys may be identified. In certain embodiments, combinations of predefined schemas and/or structures may be used, where certain defined portions of an asset file and/or set(s) of asset segments may be identified as possible candidate segments for random and/or pseudorandom selection for encryption using copy specific keys.

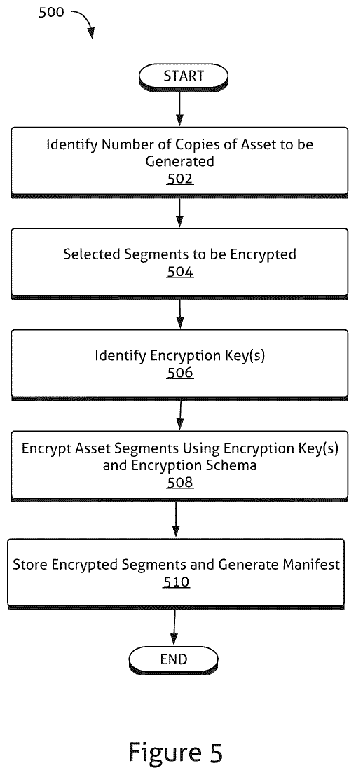

FIG. 5 illustrates a flow chart of a non-limiting example of a method 500 of generating asset copies consistent with certain embodiments of the present disclosure. The illustrated method 500 may be implemented in a variety of ways, including using software, firmware, hardware, and/or any combination thereof. In certain embodiments, various aspects of the method 500 and/or its constituent steps may be performed by a service, system, and/or device configured to implement embodiments of a media and/or packager service and/or any other suitable application, device, system and/or service or combination of applications, devices, systems, and/or services.

At 502, a number of copies of an asset to be created by the packaging service may be identified. In some embodiments, the number of copies may be specified by an authorized user and/or system interacting with the packaging service. In further embodiments, the number of copies may be specified in metadata and/or other information associated with the asset. Each copy of the asset may be assigned and/or otherwise associated with a logical ID. For example, if N copies are to be generated, then the IDs may comprise ID=[0 . . . . N−1].

A number of segments of an asset to be encrypted and a segment encryption policy, schema, and/or structure (which in certain instances herein may be used interchangeably) may be selected at 504. At 506, specific keys (e.g., common and/or copy specific encryption keys) may be identified to be used to encrypt specific segments of the asset for a particular copy.

The packaging service may encrypt the individual segments based on the identified keys and associated segment encryption policy, schema, and/or structure at 508. The encrypted segments may be stored at 510. In addition, a manifest file may be generated for each copy of the asset. In some embodiments, the manifest file may reference the segments encrypted specific for the unique copy among segments encrypted with the common encryption keys by including a specific key ID (e.g., KID), in a content protection field of the manifest file.

### Example DASH Manifest File

A manifest file (e.g., a DASH manifest file) generated from the above-detailed encryption method may be similar to the following non-limiting example:

```
<AdaptationSet>
  <ContentProtection
schemeIdUri=“urn:mpeg:dash:mp4protection:2011” value=“cenc”/>
  <ContentProtection schemeIdUri=“urn:uuid:edef8ba9-79d6-4ace-
a3c8-27dcd51d21ed”>
    <cenc:pssh>...</cenc:pssh>
  </ContentProtection>
  <Representation>
    <SegmentTemplate duration=“2” media=“segment_$Number$.m4s”
initialization=“init.mp4”/>
    <!-- Segment 1 with Key ID 1 -->
    <SegmentBase indexRange=“0-999”>
      <ContentProtection schemeIdUri=“urn:uuid:edef8ba9-79d6-
4ace-a3c8-27dcd51d21ed” cenc:default_KID=“key_id_1”/>
    </SegmentBase>
    <!-- Segment 2 with Key ID 2 -->
    <SegmentBase indexRange=“1000-1999”>
      <ContentProtection schemeIdUri=“urn:uuid:edef8ba9-79d6-
4ace-a3c8-27dcd51d21ed” cenc:default_KID=“key_id_2”/>
    </SegmentBase>
    <!-- Additional segments with different Key IDs -->
    <!-- ... -->
  </Representation>
</AdaptationSet>
```

### DRM Transactions

In various embodiments, when a valid and/or otherwise authorized user requests rights to access a copy, a DRM license may be retrieved that includes common keys for an asset as well as specific keys for a given copy of the asset. This may provide a higher level of security than conventional implementations, as additional keys may be required to access the asset. Moreover, it may be possible to track access to individual copies through a DRM transaction/interaction. For example, it may be possible to track first time use and enabling a gifting use case where a user purchases a copy of an asset for someone else. First time use of an asset may be recorded on the blockchain. In yet further embodiments, certain segments of an asset may comprise an embedded fingerprint, such as a copy ID and/or the like, enhancing the uniqueness and/or ability to identify each copy.

### Digital Content Asset Packaging, Encryption, and Storage

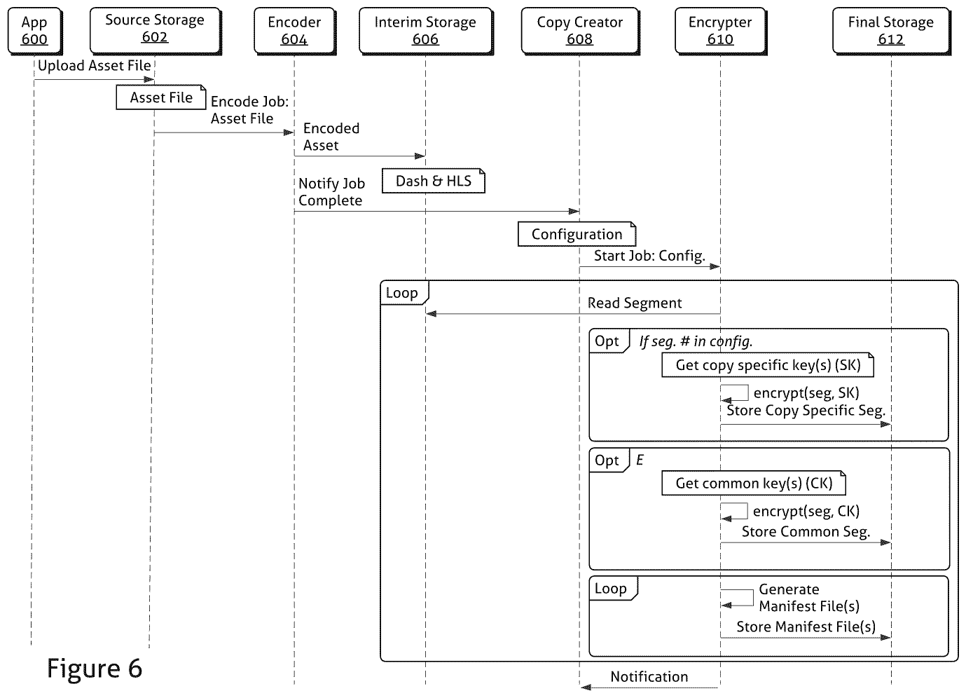

FIG. 6 illustrates a non-limiting sequence diagram of a method for packaging and encrypting a digital content asset consistent with certain embodiments disclosed herein. Various aspects of the illustrated method may be performed by systems and/or services included in and/or otherwise associated with a media service and/or a packaging service. For example, an application 600 (which may be associated with a service of a TRM service and/or a marketplace service and/or a user) may interact with various asset packaging services and/or associated stores including, for example and without limitation, source storage 602, interim storage 606, and final storage 612 data stores and/or encoder 604, copy creator 608, and/or encrypter 610 services.

As shown, the application 600 may provide the source storage 602 with an asset file for packaging via an upload process. The source storage 602 may provide the encoder service 604 with an encoding request for the asset file. The encoder service 604 may encode the asset file and provide the encoded asset file to interim storage 606. For example and without limitation, the encoder may encode the asset file into a DASH and/or HLS streaming format, which may be stored by the interim storage 606. The encoder service 604 may notify a copy creator service 608 that the encoding of the asset file has been completed.

The encoder service 604 may coordinate with an encrypter service 610 to encrypt the encoded asset file. For example, the encoder service 604 may initialize encryption of the encoded asset file with the encrypter service 610, potentially passing the encrypter service 610 with desired encryption configuration information. For example and without limitation, in some embodiments, the encrypter service 610 may be passed configuration information comprising an indication of segment numbers in a segmented asset file that should be encoded with copy specific keys.

The encrypter service 610 may read the encoded asset file from the interim storage 606. If a segment undergoing encryption is identified in configuration information passed to the encrypter service 610 as being intended to be encrypted using a copy key, the copy key SK may be retrieved, and the segment may be encrypted using the copy key and stored in final storage 612. If a segment is not identified in the configuration information as being intended to be encrypted using a copy key, the common key CK may be retrieved, and the segment may be encrypted using the common key and stored in final storage 612. For each copy of the asset file encrypted, a manifest file may be generated and stored in the final storage 612. Once the entire asset file copy has been encrypted and stored (along with an associated manifest file), the encrypter service 610 may notify the copy creator service 608.

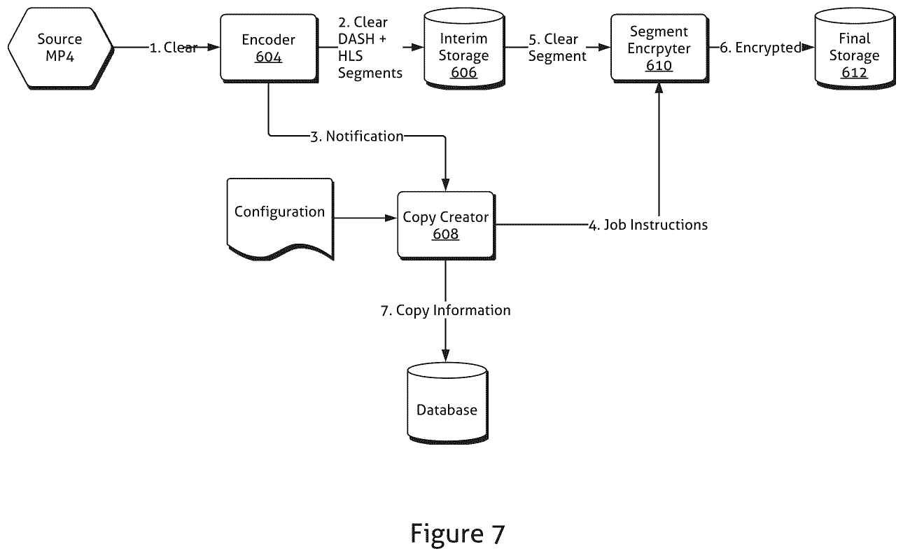

FIG. 7 illustrates a non-limiting example of various components of a packaging service for packaging and encrypting a digital content asset (e.g., an MP4 asset) consistent with certain embodiments disclosed herein. Although the example illustrated the figure shows encryption and/or packaging of an MP4 asset, it will be appreciated that the disclosed embodiments may be used in connection with a variety of types of digital assets and/or content.

As illustrated, the unencrypted MP4 asset may be provided to an encoder service 604 for encoding. The encoder service 604 may encode the MP4 asset into a desired format. For example and without limitation, the encoder service 604 may encode the MP4 asset into segmented DASH and HLS format. The encoded file(s) may be stored in interim storage 606. The encoder service 604 may notify the copy creator service 608 of the encoding of the asset, which may communication copy encryption instructions to a segment encrypter service 610, potentially based on segment and/or copy configuration information provided to the copy creator service 608. The segmented encoded asset may be provided to the segment encrypter service 610 by the interim storage 606, and the segment encrypter service 610 may encrypt the segments (e.g., encrypt using common and/or copy keys as appropriate), storing the final encrypted asset in final storage 612. Information relating to the encrypted and/or otherwise generated copy may be stored by the copy creator service 608 in a suitable database.

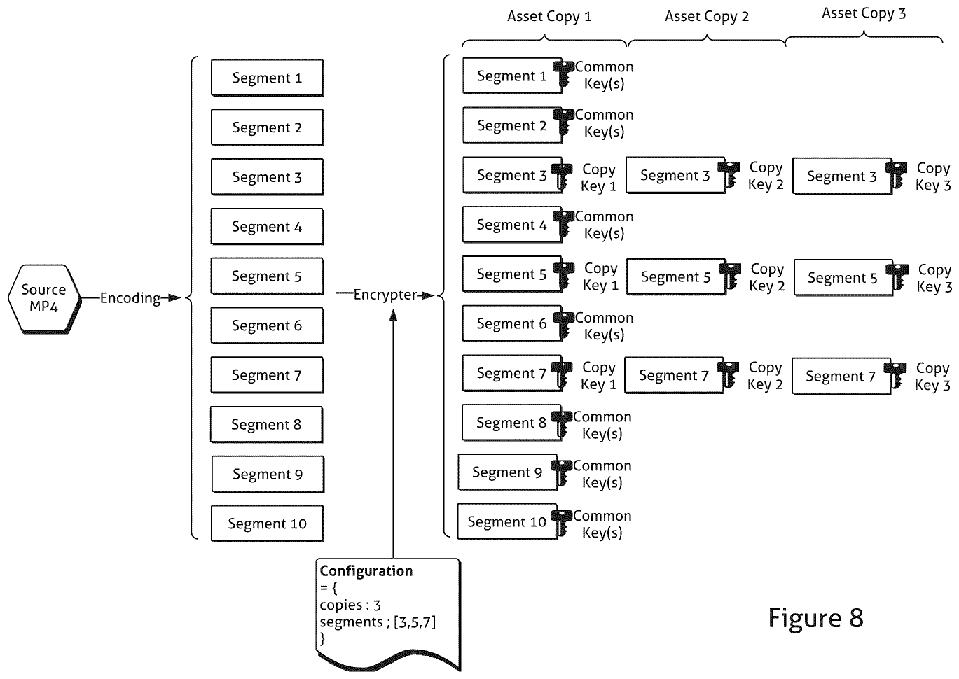

FIG. 8 illustrates a non-limiting example of the generation of encrypted copies of a digital asset consistent with certain embodiments disclosed herein. Although the example illustrated the figure shows encryption and/or packaging of an MP4 asset for purposes of explanation and illustration, it will be appreciated that the disclosed embodiments may be used in connection with a variety of types of digital assets and/or content.

Consistent with embodiments disclosed herein, the MP4 asset may be passed to an encoder, which may be encoded into a desired format (e.g., DASH, HLS, etc.) in a manner that divides the asset file into a plurality of segments (i.e., Segment 1-Segment 10 in the figure). The segmented encoded file may be passed to an encrypter service, which may use encryption configuration information to encrypt the segmented encoded file consistent with the disclosed embodiments. For example, configuration information may specify that three copies should be generated, with different keys used to encrypt segments 3, 5, and 7 unique to each copy.

When generating the three copies the encrypter service may, consistent with the configuration information, encrypt the non-specified segments using a common encryption key, but may encrypt segments 3, 5, and 7 with different encryption keys (e.g., Copy Key 1, Copy Key 2, and Copy Key 3) when generating each copy. In this manner, each copy of the asset may have its constituent segments encrypted with a unique set of encryption keys.

In certain embodiments, master and copy token minting methods may be used in connection with segment-based encryption copy packaging methods for digital assets. For example, in some embodiments, digital assets (e.g., encrypted copies of a digital asset) associated with master and copy tokens may be encrypted using various segment-based encryption techniques disclosed herein.

In additional embodiments, conditions associated with copy segment encryption may be included in metadata associated with the master token. For example and without limitation, a master token may specify one or more of an indication of a number of segments (e.g., minimum and/or maximum number) to be encrypted with copy keys per asset copy, a ratio and/or percentage of the total segments to be encrypted with copy keys, patterns of segments to be encrypted with copy keys (e.g., alternating first segment of every 10 segments, 5th segment of every 20 segments, etc.), specifically numbered segments to be encrypted with copy keys, an indication of that segments for encryption with copy keys should be randomly selected and/or selected from subsets thereof (e.g., based on segment IDS that could be included in the copy token, etc.), and/or the like.

In yet further embodiments, a master token may represent an initial copy of an asset encrypted with a particular key encryption scheme (e.g., an asset with segments encrypted with a common token and/or an initial combination of common and copy token(s)), with copy tokens being used to represent and manage further copies of the asset encrypted with other encryption key schemes (e.g., copies with segments encrypted with common tokens and various copy token(s)).

Example System and/or Service Architecture

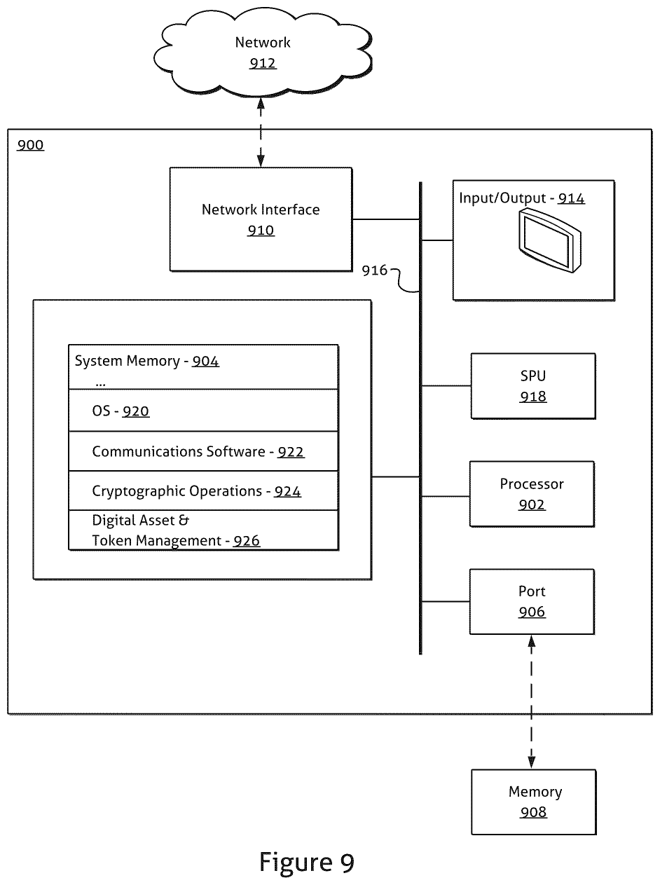

FIG. 9 illustrates a non-limiting example of a system 900 that may be used to implement certain embodiments of the systems and methods of the present disclosure. The system 900 of FIG. 9 and/or aspects thereof may be included in a system, service, and/or device associated with an asset creator, owner, and/or rightsholder, a marketplace service, a TRM service, a trusted data service, a TIDAL and/or an associated service, a DRM and/or key management service, a database service, a file storage service, a blockchain integration service, a wallet service, a blockchain service, a media packager service, cloud storage services, an orchestrator service, a blockchain connector service, and/or any other service, which may comprise a trusted service, system, and/or component configured to implement embodiments of the disclosed systems and methods and/or aspects thereof.

The various systems and/or devices used in connection with aspects the disclosed embodiments may be communicatively coupled using a variety of networks and/or network connections (e.g., network 912). In certain embodiments, the network 912 may comprise a variety of network communication devices and/or channels and may utilize any suitable communications protocols and/or standards facilitating communication between the systems and/or devices. The network 912 may comprise the Internet, a local area network, a virtual private network, and/or any other communication network utilizing one or more electronic communication technologies and/or standards (e.g., Ethernet or the like). In some embodiments, the network 912 may comprise a wireless carrier system such as a personal communications system (“PCS”), and/or any other suitable communication system incorporating any suitable communication standards and/or protocols. In further embodiments, the network 912 may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In certain embodiments, the network 912 may incorporate one or more satellite communication links. In yet further embodiments, the network 912 may utilize IEEE's 802.11 standards, Bluetooth®, ultra-wide band (“UWB”), Zigbee®, and or any other suitable standard or standards.

The various systems and/or devices used in connection with aspects of the disclosed embodiments may comprise a variety of computing devices and/or systems, including any computing system or systems suitable to implement the systems and methods disclosed herein. For example, the connected devices and/or systems may comprise a variety of computing devices and systems, including laptop computer systems, desktop computer systems, server computer systems, distributed computer systems, smartphones, tablet computers, and/or the like.

In certain embodiments, the systems and/or devices may comprise at least one processor system configured to execute instructions stored on an associated non-transitory computer-readable storage medium. As discussed in more detail below, systems used in connection with implementing various aspects of the disclosed embodiments may further comprise a secure processing unit (“SPU”) configured to perform sensitive operations such as trusted credential and/or key management, cryptographic operations, secure policy management, and/or other aspects of the systems and methods disclosed herein. The systems and/or devices may further comprise software and/or hardware configured to enable electronic communication of information between the devices and/or systems via a network using any suitable communication technology and/or standard.

As illustrated in FIG. 9, the example system 900 may comprise: a processing unit 902; system memory 904, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 902; a port 906 for interfacing with removable memory 908 that may include one or more diskettes, optical storage mediums (e.g., flash memory, thumb drives, USB dongles, compact discs, DVDs, etc.) and/or other non-transitory computer-readable storage mediums; a network interface 910 for communicating with other systems via one or more network connections and/or networks 912 using one or more communication technologies; a user interface 914 that may include a display and/or one or more input/output devices such as, for example, a touchscreen, a keyboard, a mouse, a track pad, and the like; and one or more busses 916 for communicatively coupling the elements of the system.

In some embodiments, the system 900 may, alternatively or in addition, include a trusted execution environment and/or an SPU 918 that is protected from tampering by a user of the system or other entities by utilizing secure physical and/or virtual security techniques. A trusted execution environment and/or a SPU 918 can help enhance the security of sensitive operations such as personal information management, trusted credential, token, and/or key management, privacy and policy management, and other aspects of the systems and methods disclosed herein. In certain embodiments, the trusted execution environment and/or SPU 918 may operate in a logically secure processing domain and be configured to protect and operate on secret information, as described herein. In some embodiments, the trusted execution environment and/or a SPU 918 may include internal memory storing executable instructions or programs configured to enable the SPU 918 to perform secure operations, as described herein.

The operation of the system 900 may be generally controlled by the processing unit 902 and/or an SPU 918 operating by executing software instructions and programs stored in the system memory 904 (and/or other computer-readable media, such as memory 908, which may be removable). The system memory 904 may store a variety of executable programs or modules for controlling the operation of the system. For example, the system memory may include an operating system (“OS”) 920 that may manage and coordinate, at least in part, and/or system hardware resources and provide for common services for execution of various applications.

The system memory 904 may further include, without limitation, communication software 922 configured to enable in part communication with and by the system, one or more applications, a cryptographic operation module 924 configured to perform various aspects of the disclosed embodiments (e.g., cryptographic key and hash generation operations, key management operations, token minting and other operations, encryption operations, etc.), one or more digital asset and/or token management modules 926 configured to perform various aspects of the methods disclosed herein, and/or any other information, modules, and/or applications configured to implement embodiments of the systems and methods disclosed herein.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. For example, it will be appreciated that a number of variations can be made to the various embodiments, systems, services, and/or components presented in connection with the figures and/or associated description within the scope of the inventive body of work, and that the examples presented in the figures and described herein are provided for purposes of illustration and explanation, and not limitation. It is further noted that there are many alternative ways of implementing both the systems and methods described herein. Accordingly, the present embodiments are to be considered as illustrative and not restrictive, and the embodiments of the invention are not to be limited to the details given herein but may be modified within the scope and equivalents of the appended claims.

1. A method for managing a digital asset performed by a ledger service executing on a system comprising a process and a non-transitory computer-readable storage medium storing instructions that, when executed by the processor, cause the system to perform the method, the method comprising:
receiving, by the ledger service, a request to generate a plurality of non-fungible tokens associated with an asset, the request comprising one or more token minting parameters, the token minting parameters comprising an indication that N non-fungible tokens should be minted by the ledger service in response to the request;
generating, by the ledger service based on the request, a master token, the master token comprising a token identifier associated with the master token and metadata associated with the asset;
recording the generated master token in a trusted ledger managed by the ledger service;
generating, by the ledger service based on the request, a set of N−1 copy tokens, wherein each copy token of the set of N−1 copy tokens comprises a copy token identifier associated the respective copy token and a reference to the master token; and
recording the each copy token of the set of N−1 copy tokens in a trusted ledger managed by the ledger service.

2. The method of claim 1, wherein the request to the generate the plurality of non-fungible tokens is received from a token rights management service.

3. The method of claim 2, wherein the request to generate the plurality of non-fungible tokens is received from a blockchain connector service of the token rights management service.

4. The method of claim 1, wherein the metadata comprises one or more of title information associated with the asset, description information associated with the asset, ownership information associated with the asset, and an indication of a location of the asset.

5. The method of claim 4, wherein the indication of the location of the asset comprises a URL location for accessing the asset.

6. The method of claim 1, wherein the reference to the master token comprises the token identifier associated with the master token.

7. The method of claim 1, wherein the master token further comprises a token serial number corresponding to an initial token serial number for the asset.

8. The method of claim 7, wherein each copy token of the set of N−1 copy tokens comprises a token serial number for the respective copy token.

9. The method of claim 1, wherein the asset comprises a digital asset.

10. The method of claim 9, wherein the digital asset comprises a content asset.

11. The method of claim 10, wherein the content asset comprises one or more of text content, audio content, and video content.

12. The method of claim 10, wherein the content asset comprises a plurality of content segments.

13. The method of claim 12, wherein the plurality of content segments comprise encrypted content segments.

14. The method of claim 13, wherein a first subset of the content segments are encrypted with one or more common encryption keys and a second subset of the content segments are encrypted with one or more copy encryption keys.

15. The method of claim 1, wherein the trusted ledger comprises cryptographically linked entries.

16. The method of claim 15, wherein the trusted ledger comprises a trusted immutable distributed assertion ledger.

17. The method of claim 16, wherein the trusted immutable distributed assertion ledger comprises a blockchain ledger.
